(19) United States
(12) Patent Application Publication
(10) Pub. No.: US 2009/0122976 A1
(43) Pub. Date: May 14, 2009

(54) WIRE GUIDE PLATE AND ASSEMBLY AS WELL AS A TELECOMMUNICATIONS MODULE COMPRISING AT LEAST ONE WIRE GUIDE PLATE

(76) Inventors: Wolfgang Edelmann, Wuppertal (DE); Christine B. Bund, Wuppertal (DE); Axel Koruschowitz, Haan (DE); Johann G. Hajok, Bochum (DE)

Correspondence Address: 3M INNOVATIVE PROPERTIES COMPANY, PO BOX 33427, ST. PAUL, MN, 55133-3427, US

(21) Appl. No.: 11/813,391

(22) PCT Filed: Jan. 3, 2006
(86) PCT No.: PCT/US2006/000071

§ 371 Date: Mar. 25, 2008

(30) Foreign Application Priority Data
Jan. 10, 2005 (EP) 05000346.6

(51) Int. Cl. H04M 1/00; H02G 3/04

(52) U.S. Cl. 379/413.04; 174/97

(57) ABSTRACT

A wire guide plate (10) for guiding at least one wire (12, 14) to a front side thereof comprises at least one first wire guide (16) formed on a first surface (18) of the wire guide plate (10), and at least one through opening (20) is formed in the vicinity of the first wire guide (16) so as to guide a wire (12) which is guided by the first wire guide (16) to a second surface of the wire guide plate (10) opposite of the first surface (18).

### TECHNICAL FIELD

The invention relates to a wire guide plate and an assembly as well as a telecommunications module comprising at least one wire guide plate.

### BACKGROUND

In the field of telecommunications, numerous customers are connected with the switch of a telecommunications company via telecommunications lines. The customers can also be called subscribers. The switch is also called an exchange or PBX (central office exchange operated by the telecommunications company). Between the subscriber and the switch, sections of the telecommunications lines are connected with telecommunications modules. The telecommunications modules establish an electrical connection between a wire which is attached to the telecommunications module at a first side, and another wire which is attached to the telecommunications module at a second side. The wires of one side can also be called incoming wires and the wires of the other side can be called outgoing wires. Plural telecommunications modules can be put together at a distribution point, such as a main distribution frame, an intermediate distribution frame, an outside cabinet or a distribution point located, for example, in an office building or on a particular floor of an office building. To allow flexible wiring, some telecommunications lines are connected with first telecommunications modules in a manner to constitute a permanent connection. Flexibility is realized by so-called jumpers or cross connects, which flexibly connect contacts of the first telecommunications module with contacts of a second telecommunications module. These jumpers can be changed when a person moves within an office building to provide a different telephone (i.e. a different telephone line) with a certain telephone number, which the relocated person intends to keep.

Recently, ADSL-technology has spread widely in the field of telecommunications. This technology allows at least two different signals to be transmitted on a single line. This is achieved by transmitting the different signals at different frequencies along the same line. The signals are combined at a particular point in the telecommunications line and split at another point. In particular, at the subscriber side, voice and data signals, which are separate, are combined and sent to the central office via the same line. In the central office the combined signal is split. For the transmission of voice and data signals to the subscriber, separate voice and data signals are combined at the central office, sent to the subscriber and split at the subscriber side. After splitting the signal, the so-called POTS-signal (plain old telephone service) can be used to transmit voice signals. The remaining part of the split signal can be used to transmit data, for example. So-called splitters, which are used to split or combine the signal, can generally be arranged at any distribution point. In this context, a POTS wire or POTS jumper indicates a wire, which is connected with an exchange of the telecommunications company. Furthermore, a line connection indicates a wire, which leads to the subscriber or customer. Finally, as discussed in more detail below, a DSLAM-wire means a wire which is connected with a DSLAM and thus, can, for example, transmit data. A DSLAM (Digital Subscriber Line Access Multiplexer) processes the data signal. In the above described distribution points, an efficient arrangement of the wires, or cables including plural wires, is desirable. A widely used arrangement for guiding wires is explained below with reference to a main distribution frame. However, the explanation is applicable to other distribution points. In a main distribution frame, a plurality of wires leading to the subscribers are guided into the distribution point at the subscriber side. At the so-called “backbone” side of the main distribution frame, the cables leading to the switch are terminated, i.e. connected with contacts.

In order to achieve flexibility, telecommunications modules or blocks comprising plural modules are used at both the subscriber and the backbone side. The telecommunications modules usually have at least two rows of contacts. The wires leading to the subscribers are connected at a first row of the subscriber side telecommunications module. Jumpers are connected at the second row of contacts in the subscriber side telecommunications module. These jumpers are, at their other end, connected at a first row of contacts in the backbone side telecommunications module. Wires leading to the switch are connected with the second row of contacts in the backbone side telecommunications module.

In telecommunications systems, such as the main distribution frame described above, it is usually desirable to guide the incoming and outgoing wires, which are connected at different contact rows of a telecommunications module, to different sides of the telecommunications module. In a telecommunications module, which is arranged so that the rows of contacts are substantially horizontal, wires connected to a lower row of contacts can be guided to one side, i.e. the left or right side of the telecommunications module, and the wires connected to the upper row of contacts can be guided to the other side, i.e. the right or left side. When a telecommunications module is arranged so that the rows of contacts are substantially vertical, corresponding considerations apply, i.e. the wires are guided to the top or bottom side. As regards further details of wire guiding in general, reference can be made to the applicant's WO 03/061303 A2.

This document describes a terminal block which comprises, on at least one side thereof, i.e. the top or bottom side, at least two arrays of wire guides. In this manner, the versatility is improved, as the wires can, at the top or bottom side of the terminal block, be guided to either side, i.e. the left or right side. However, the additional array of wire guides, which are provided on at least one side, add to the height of the terminal block, i.e. the dimension from top to bottom when the arrays of wire guides are provided on the top and bottom side.

### SUMMARY OF THE INVENTION

The invention provides a wire guide plate for guiding wires to contacts of a telecommunications module, which enhances the versatility in connection with guiding the wires and, furthermore, conserves space so as to allow an increase in the density of telecommunications modules provided in a distribution point. The invention, moreover, provides an assembly of at least one wire guide plate and a contact module as well as a telecommunications module comprising such a wire guide plate, with which the mentioned advantages can be achieved.

The wire guide plate described herein, which serves to guide at least one wire to a front side thereof and to a contact of a telecommunications module, is considered a plate as compared to a box or cuboid-type object for the following reasons. A plate can be described to be relatively thin with two relatively large main surfaces and at least one relatively shallow, strip-like side surface. The wire guide plate describe herein has this type of general appearance with details described below. The plate described herein can have any suitable shape, with a substantially rectangular shape being currently preferred.

In particular, the wire guide plate comprises, formed on a first surface thereof, at least one wire guide. The first surface is constituted by one of the main surfaces of the plate. The wire guide can have any structure suitable for guiding a wire. For example, the wire guide can be formed by one or more ridges which determine, possibly in cooperation with further components, the direction in which a wire will move, when it is inserted along the guide so as to move along the ridge. The wire guides can also be formed as open or closed troughs or channels, which serve to guide a wire.

In the novel wire guide plate, at least one through opening is formed in the vicinity of the first wire guide. The through opening can generally be described to be a hole or cutout in the main surfaces of the wire guide plate. The through opening generally allows a wire to pass from one main surface of the plate to the other one. In particular, the through opening, in combination with the described first wire guide, serves to guide a wire, which is guided by the first wire guide, to a second surface of the wire guide plate, i.e. the surface opposite of the first surface, where the first wire guide is formed. The fact, that the through opening is formed in the vicinity of the first wire guide, merely implies that the first wire guide and the through opening cooperate, in any suitable manner, so as to allow the wire to pass from the first to the second surface.

In this context, it should be noted that the wire guide plate does not necessarily have to be an integral or a one-piece plate. Whereas such an integral or one-piece structure is currently preferred, the wire guide plate can have a structure including more than one component. For example, a first component can be constituted by a plate containing the at least one through hole, which plate will preferably be entirely flat. A second plate, on a surface of which the first wire guide is formed, can be combined with the plate comprising the through openings so as to achieve the desired effects. For example, the second plate can have one or more ridges formed thereon, which constitutes the wire guides. When the upper edges of the ridges are in contact with the surface of the above-described first plate, which comprises the through openings, the wire guides can be described to be closed by the cooperation of the wire guiding ridges and the surface of the first plate. Moreover, either one of the described plates, which in cooperation constitute the wire guide plate described herein can have a suitable deflector or, as described below, roof-type element, which causes the wire guided by the wire guide to pass through the through opening.

It is to be understood, that the above-described structures comprising two plates constitutes a wire guide plate as described herein, when the two plates are combined with each other. Thus, the wire guides can be formed on one of the surfaces of one of the described plates, which can be called an internal surface of the resulting, complete wire guide plate.

With the structure described above, i.e. with the through openings, the wire guide plate described herein achieves the following advantages. In essence, both surfaces of the wire guide plate can be efficiently used by allowing wires to pass from the first to the second surface. Thus, both surfaces of the wire guide plate can be used for guiding wires, in particular from different sides thereof to a front side, where the contacts of a telecommunications module are exposed. In particular, a second array of wire guides which adds to the thickness of the wire guide plate is not needed. Rather, wires can be guided on both surfaces of the wire guide plate, and can be guided in parallel on at least a part of one surface thereof. This particularly applies to a region between the one or more through openings and the front side of the wire guide plate, where the wires are to be guided to. In a relatively rearward part, the wires can be guided on different surfaces of the wire guide plate. In particular, the wire guides on different surfaces can be formed so as to guide the wires on different surfaces to different sides, i.e. the left or right side thereof. However, in a front part, in particular between the one or more through openings and the front side, the wires can, since they have passed through the through openings to the other side, be guided on a single side which reduces the thickness of the wire guide plate. Therefore, the density of telecommunications modules in a distribution point can be increased. Furthermore, these effects can be obtained by providing a single wire guide plate, which is advantageous under economical aspects.

Finally, the novel wire guide plate achieves a remarkable versatility for guiding wires. As described above, at least in a rear part thereof, the wire guides on different surfaces can be formed so as to guide the wires to different sides of the wire guide plate. This means, when viewed from a different guiding direction, that the wires can be guided to the contacts of a telecommunications module from different sides thereof. In particular, wires which are to be connected at one and the same row of contact of the telecommunications module, i.e. that row which is adjacent to the novel wire guide plate, can be guided to these contacts from different sides, i.e. the left or right side of the telecommunications module. This enhances the versatility and at the same time allows an efficient arrangement of wires as well as cables including plural wires in the surroundings of a telecommunications module, which is combined with the novel wire guide plate. Thus, an efficient guiding of wires and cables can be realized in a distribution point. Also, line sharing can be realized by using the wire guide plate described herein. Line sharing is, for example, realized, when different providers use one and the same telecommunications line. For example, one provider can provide POTS- and another provider can provide DSL-services. These providers use one and the same telecommunications line and establish connections at one and the same distribution point. In such a situation, it provides advantages, when the wires of different providers are guided to the front side of a telecommunications module from different sides thereof. This provides a good overview and an advantageous separation between the wires of different providers.

As already indicated above, the novel wire guide plate can comprise at least one second wire guide formed on the second surface thereof. Thus, wires can reliably be guided on both surfaces of the wire guide plate. In particular, plural wires can be guided in parallel in a certain region of the second surface, typically a front region of the wire guide plate, i.e. an area, where the wires originating from the first surface are guided when they have passed through the through opening. As regards the second wire guides, it should be mentioned that the above consideration regarding plural components constituting the novel wire guide plate, fully apply. In other words, the second wire guides can also be formed on a separate component which can be combined with a first component, such as a plate comprising the through openings and/or the first wire guides, so as to constitute the wire guide on the second surface.

The first and/or second wire guide can have any suitable structure, which sufficiently guides a wire, which is moved along or inserted into the wire guide. It is currently preferred to provide at least one ridge, which constitutes the wire guide. In particular, two substantially parallel ridges can, in cooperation with a part of the surface, on which they are formed, constitute a trough-like wire guide, which could also be considered an open channel. The one or more ridges could also be called webs or partition walls. The described trough-like wire guides could be closed by a separate or integral, typically plate-like cover, so as to form one or more closed channels.

When the wire guides are formed by one or more ridges, it has been found advantageous, that the ridge extends to a side edge of the through opening. In this manner, the wire can efficiently traverse the through opening, when it is directed by the first wire guide.

It has, moreover, been shown, that the passing of the wire through the through opening can be efficiently realized by providing at least one roof-type element, which at least partially and on at least one surface of the wire guide plate covers the through opening. Since the plate, in which the through opening is formed, does not necessarily have to be entirely flat, the plate can comprise a suitable step or a similar structure so as to bring the through opening into a position, where the wire will automatically pass through so as to be guided to the other surface. However, in particular when the plate is substantially flat, a roof-type element at least partially covering the through opening has been found advantageous in order to cause the wire to pass through the opening. As mentioned, the roof-type element serves to guide the wire from one surface to the other surface. In particular, the roof will cause the wire, which is guided on that surface, where the roof covers the opening, to the other surface. When there are wires, which should be guided from both surfaces to the respective other surface, the described roof-type elements can be provided on both surfaces covering respective openings from different sides, or, as an alternative, covering one or more openings on both sides thereof.

Generally, certain advantages can be obtained by the general structure of the novel wire guide plate including at least one through opening. However, enhanced versatility can particularly be realized by providing the first and second wire guides so as to extend from opposite sides of the wire guide plate towards a front side thereof. In this context, the front side is considered that side of the wire guide plate, where the wires are to be guided, i.e. a side, where contacts of a telecommunications module, with which the wire guide plate is combined, or into which it is incorporated, are exposed. In this respect, the above-referenced first and second main surfaces of the wire guide plate constitute a top or bottom surface. The wire guides formed thereon serve to guide the wires between the above-mentioned front side and the left and right side respectively. When the wire guides on different surfaces extend from opposite sides, wires from both sides, i.e. the left and right side, can be guided to the contacts of a telecommunications module at a top or bottom side thereof. Thus, wires from both sides can be connected with the contacts of one and the same contact row of a telecommunications module, i.e. a top or bottom, horizontally oriented row of contacts. In specific applications, the wire guides can also be formed so as to guide the wires to a rear side. In particular, a wire guide starting from one particular side, i.e. the left or right side, can be formed so as to extend to the front side, and the wire guide starting from the other side, i.e. the right or left side, can be formed so as to extend to the rear side.

It is to be understood that the corresponding considerations apply for an orientation in which the contacts of the telecommunications module are arranged in substantially vertical rows.

In order to make efficient use of the space, which is available on and adjacent the wire guide plate, it has been found beneficial to form at least some of the first or second wire guides so as to extend from one side of the wire guide plate at a position further rearwards than the other wire guides. In other words, the entries of wire guides, i.e. the location from which they extend or start, can be formed in a further rearwards area on one surface of the wire guide plate, than the entries of the wire guides of the other side. Thus, the rearward area of at least one surface is essentially free of wire guides and can be used for accommodating certain components.

In particular, at least one engaging or mounting structure, with which the wire guide plate is provided, can be formed in such an area. The engaging or mounting structure can be particularly formed in a rear part of the wire guide plate and serves to engage with or mount at least one object or component, such as a printed circuit board, a shielding plate and/or a protection device. The printed circuit board can for example carry electrical components, particularly splitter circuits for ADSL-technology. A shielding plate can be provided, in order to shield any adjacent components from cross talk and similar influences. Finally, a protection device can be an over-voltage and/or over-current protection magazine.

Further advantages with regard to guiding the wires particularly at a front side of the wire guide plates can be achieved when the wire guide plate comprises at least one finger, which extends from the front side thereof. The finger can also be called a projection or tab and serves to separate those wires, which are to be connected to a particular contact or a group of contacts, from other wires, which are to be connected to adjacent contacts or adjacent groups of contacts.

It has, furthermore, proven advantageous to form at least one mounting hook on the novel wire guide plate, which serves to mount the wire guide plate to a carrier in the field of telecommunications. In this manner, an efficient and reliable attachment of the wire guide plate and/or an assembly or telecommunications module combined or equipped therewith, can be realized.

Generally, the wire guide plate described herein can have any suitable structure, i.e. made from a single, two or more pieces, and can, furthermore, be formed from any suitable material such as metal or plastic. It is, however, currently preferred to form the wire guide plate integrally, i.e. in one piece, with plastic material being preferred. The wire guide plate can, for example, be produced by injection molding.

Generally, the wire guide plate described herein leads to increased versatility and can be used in a telecommunications system in many different ways. For example, an assembly comprising at least one wire guide plate as described herein and at least one contact module can be provided. A contact module describes a module which at least comprises one or more contact, to which wires can be connected. In addition, the contact module can include separable disconnection points between contacts and/or further components, such as protection devices and splitters.

This also applies to a telecommunications module comprising at least one wire guide plate as described herein. The telecommunications module can comprise one or more contacts, which are exposed so as to allow for the connection of wire therewith. The contacts can be arranged in rows. The wire guide plate can be suitably attached to the housing of the telecommunications module. As an alternative, the wire guide plate can be formed integral with the housing of the telecommunications module.

As regards the above-mentioned contact module or the telecommunications module, it is currently preferred that these are formed as or comprise disconnection modules. This implies that they comprise one or more separable disconnection points between contacts so as to separate or disconnect a connection for inserting devices such as test plugs or splitters, which serve to split a signal and feed the split signal to at least two separate contacts.

As indicated above, the wire guide plate described herein can be provided so as to further comprise at least one cover plate. The cover plate can be formed so as to cover the first and/or second wire guides, which can be formed as at least partially open wire guides on the wire guide plate. Moreover, such a cover plate can also be provided in combination with the assembly described above or on the telecommunications module described above.

In particular, the cover plate can comprise the first and/or second wire guides at least partially formed thereon. For example, the ridges which form part of the wire guide can be formed on the cover plate. Moreover, the cover plate can have a shallow, box-like structure with wire guides at least partially formed on the interior surfaces thereof, so that a second component, which can comprise the through openings, can be accommodated in the interior of such a cover plate so as to constitute the completed wire guide plate. Finally, the cover plate can also comprise one or more of the roof-type elements described above formed integrally thereon.

### BRIEF DESCRIPTION OF THE DRAWINGS

Hereinafter the invention will be described by non-limiting examples thereof with reference to the drawings, in which:

FIG. 1 shows a perspective view of the wire guide plate from a first surface thereof;

FIG. 2 shows the wire guide plate of FIG. 1 from a second surface thereof; and

FIG. 3 shows a perspective view of a telecommunications module comprising the wire guide plate of FIG. 1.

### DESCRIPTION OF A PREFERRED EMBODIMENT OF THE INVENTION

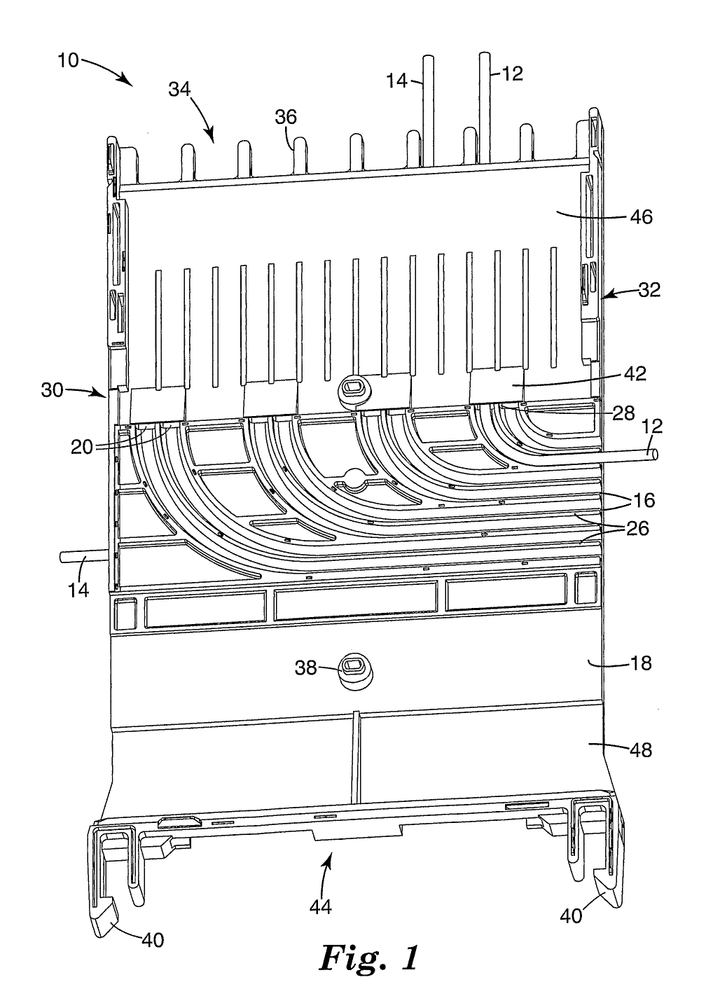

FIG. 1 shows a perspective view of the wire guide plate 10 from a first surface 18 thereof. As can be taken from the drawing, a plurality of, in the case shown, eight first wire guides 16 are formed on the first surface 18. The wire guides 16 are, in the embodiment shown, each formed by two ridges 26 with two adjacent wire guides 16 sharing one ridge 26 between them. The ridges 26 are essentially formed as partition walls or web-like protrusions extending from the surface 18 of the wire guide plate 10. When viewed with regard to an extension from the front 34 to a rear side 44 of the wire guide plate 10, the wire guides 16 start in a center portion thereof at right side 32. In other words, wires, such as wire 12 shown in the drawing, which are to be guided to the front side 34, where contacts of a telecommunications module (not shown) are exposed, are inserted into the wire guides 16 from this right side 32.

For a certain distance all wire guides 16 extend substantially straight and parallel to each other. Depending on their location with regard to the front-rear direction, the wire guides 16 then are formed arc-shaped beginning at different locations in the left-right direction so as to extend to respective through openings 20. In the embodiment shown, the wire guides 16 are formed spaced apart in the arc-shaped portion thereof so as to extend to the respective through openings 20, which are also formed spaced apart from each other. In the embodiment shown, two through openings 20 and corresponding wire guides 16 are provided in pairs, with four pairs being present in the embodiment shown.

As can be seen in FIG. 1, the ridges 26 forming the wire guides 16 are formed so as to extend to the side edges 28 of the through openings 20. This aids in guiding any wire 12, which is guided by the first wire guide 16, through the through opening 20. This effect is enhanced by roof-type elements 42 which at least partially cover the through openings 20. In a region adjacent the opening, the height of the ridges 26, forming the wire guide 16, is continuously decreased and a roof-type element 42 is formed so as to at least partially cover the through openings 20 in that part of the ridges 26, where their height decreases. Thus, the roof-type elements 42 are inclined relative to the first surface 18 of the wire guide plate 10. As an alternative, the surface 18 could comprise a step in the area, where the through openings 20 are formed, with the through openings being formed in the step. In this manner a wire, which is guided in wire guide 16 is automatically caused to pass through the through opening 20.

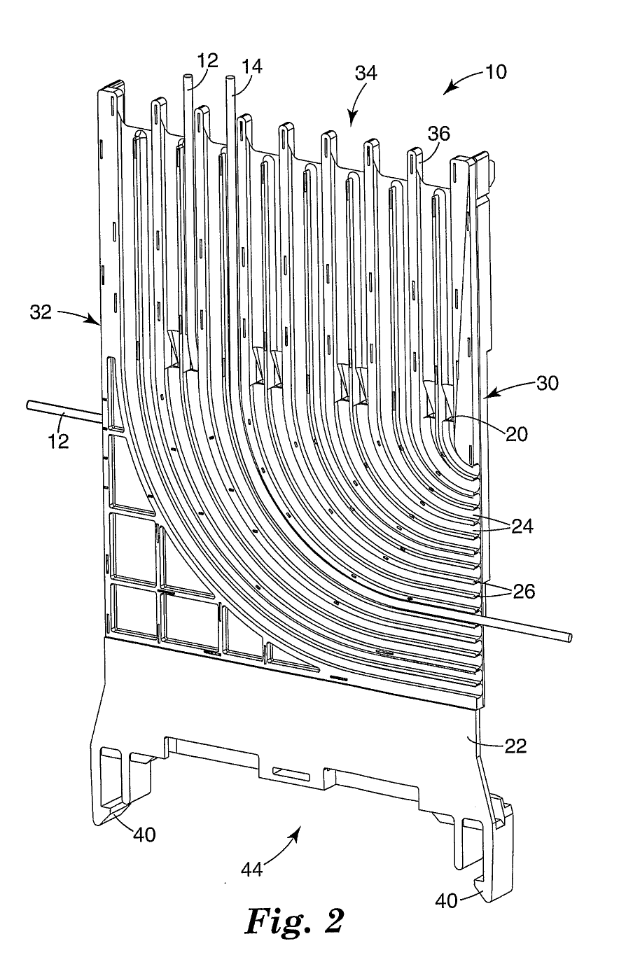

In a region between through opening 20 and the front side 34 of the wire guide plate 10, the wire 12, which was guided by first wire guide 16 on the first surface 18 of the wire guide plate 10, is guided by suitable wire guides formed on the second surface 22 of the wire guide plate 10, which is shown in FIG. 2 and will be described in more detail below. However, in the area between through opening 20 and the front side 34 of the wire guide plate 10, the first surface 18 of the wire guide plate 10 lacks wire guides and forms a relatively flat surface. This surface, in particular the front part 46 thereof, which is shown in a light color in the drawing, can be used to provide an abutment surface for a contact module of a telecommunications module, with which the wire guide plate 10 shown can be combined. Thus, contacts of the contact or telecommunications module will be exposed near the front side 34 of the wire guide plate, so that any wires 12, 14, which have been guided to the front side 34, can be connected with the contacts in an efficient and uncluttered manner. This is supported by the provision of fingers 36, which provide partitions between wires 12, 14 or pairs or groups of wires.

As shown in FIG. 1, the wire guide plate 10 comprises, in a rear part 48 thereof, a relatively flat surface, which can act as an abutment area for objects such as a printed circuit board carrying splitter circuits, and/or a shielding plate and/or protection devices. In particular, in the embodiment shown, a mounting structure 38 in the form of an approximately cylindrical protrusion can be provided in this area. In particular, the mounting structure 38 can be formed, as seen in a left-right direction, a central area. As an alternative, the mounting structure 38 could also be formed as an indentation or hole. In the rearmost part of the wire guide plate 10, a mounting hook 40 is formed on both the left 30 and right side 32 of the wire guide plate. The mounting hooks 40 are formed flexible and so as to comprise a projection, so that a reliable mounting to a carrier in the field of telecommunications can be realized.

FIG. 2 shows the second surface 22 of the wire guide plate 10 shown in FIG. 1. As can be taken from the drawing, second wire guides 24 are formed on the second surface 22. These are in a similar manner as the first wire guides 16, which are visible in FIG. 1, also formed by substantially parallel ridges 26 and extend from the left side 30 of the wire guide plate 10, which is located on the right of FIG. 2. The second wire guides 24 extend substantially parallel and substantially straight in a first part thereof, before they are formed arc-shaped up to the through openings 20 and are again formed substantially straight between the through openings 20 and the front side 34 of the wire guide plate. Any wires 14, which are inserted from the left side 30 of the wire guide plate 10, can be guided to the front side 34 of the wire guide plate. As can be taken from FIG. 2, a wire 12, which is inserted from the right side 32 of the wire guide plate, and which was visible in FIG. 1 between the right side 32 and the through opening 20, is, in the region between the through openings 20 and the front side 34 of the wire guide plate, guided on the second surface 22. Thus, in the area of the front side 34, both wires 12 and 14, are guided on one and the same surface 22 of the wire guide plate 10, although they originate from different sides 30, 32. This is realized by providing the through openings 20 and provides enhanced versatility without requiring additional space in a direction perpendicular to the surfaces 18, 22 of the wire guide plate and without requiring a second wire guide plate. It can, furthermore, be noted that in use, not all of the wire guides 16, 24 shown will necessarily be filled with wires. In particular, it can be taken from FIG. 2, that some of the second wire guides 24 lead to the through openings 20, where wires 12 from the first surface 18 pass to the second surface 22 visible in FIG. 2. Thus, that portion of these second wire guides 24, which extends between the through openings and the left side 30, can remain free of wires. However, in certain applications wires can be inserted into the wire guides 24, which lead to through openings 20 so that two or more wires can be accommodated at the same time in the regions between the through openings 20 and the front side 34. It can finally be taken from the drawing that, in the embodiment shown, the fingers 36 are formed as extensions of some of those ridges 26, in particular every other ridge, which form the second wire guide 24.

It should finally be mentioned that both the first 16 and the second wire guides 24 appear as trough-like structures or open channels, as substantially parallel ridges are formed on surfaces 18 and 22 of the wire guide plate 10. However, these open wire guides can be closed by means of further components, such as a substantially flat cover, which can be placed on surface 18 and/or 22. Furthermore, the wire guide plate 10 can, with either of its surfaces 18 and 22, be arranged so as to be in contact with an essentially flat surface, which can, for example, be provided on a housing of a telecommunications module. Thus, the wire guide 10 can be provided on a contact or telecommunications module in a sandwich-like structure so as to generate closed wire guides, which will ensure a reliable guiding of wires to the front side 34 of the wire guide plate 10. Usually, this front side will correspond to an area where contacts of a contact or telecommunications module are exposed.

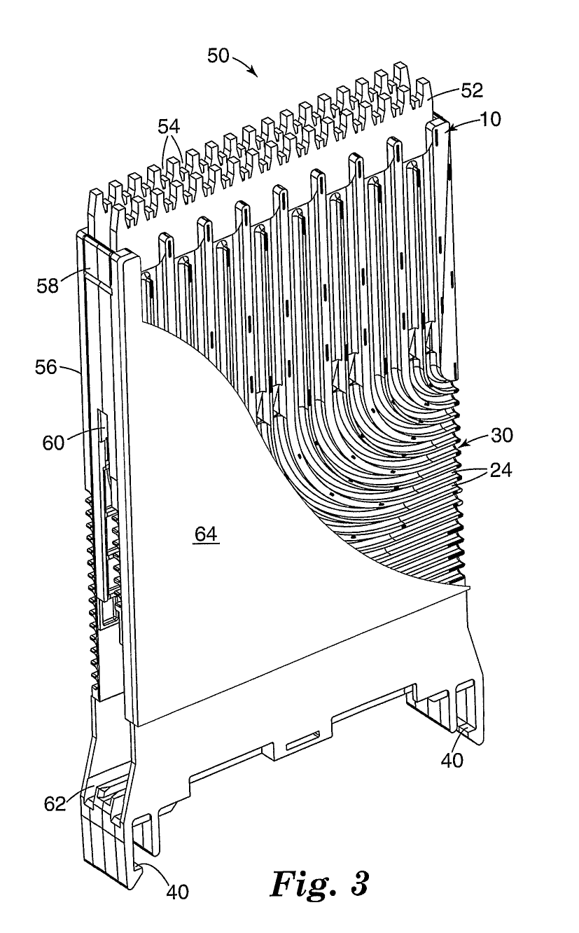

This can be taken from FIG. 3. FIG. 3 shows a perspective view of a telecommunications module 50 comprising at least one wire guide plate 10, as described above. In the embodiment shown, the telecommunications module 50 comprises a disconnection module 52 which describes a module, in which contacts 54, which are exposed at a front side 34 thereof, are connected in a separable manner. In other words, they can be disconnected, in order to insert electrical components, such as test plugs or splitter circuits between them.

In the case shown, the disconnection module 52 is attached to the housing 56 of the telecommunications module 50 by a latch mechanism 58. The housing is essentially made of two wire guide plates, the wire guide plate directed to the viewer being the wire guide plate 10 described above, two short sidewalls 60, which connect the wire guide plates, and a bottom 62. Two adjacent bottom portions can be formed integrally with the wire guide plates. This is also the case for the latch hooks 40 provided at the rear side 44, as can also be taken from FIGS. 1 and 2. In the embodiment shown, the housing 56 of the telecommunications module is laterally open in the area rearwards from the sidewalls 60, in order to allow the insertion of splitter circuits and other electrical components or printed circuit boards carrying such components, as desired.

It is to be noted that the second surface 22 of the wire guide plate 10 is directed to the viewer of FIG. 3, which corresponds to the fact that the second wire guides 24, which are formed on the second surface 22 are accessible from the left side 30, which is the right side in FIGS. 2 and 3. As can be taken from the opposite edge of the wire guide plate 10, shown in FIG. 3, the first wire guides, which are not visible in FIG. 3, are accessible from the right side 32. Moreover, in the direction towards the disconnection module 52, the first wire guides can be closed by any suitable element, such as a substantially flat cover plate. In FIG. 3, such a cover plate 64 is shown partially cut away from the second wire guides 24. The cover plate 64 is substantially flat and covers the second wire guides 24 by being laid onto the ridges 26, which define the second wire guides 24. Thus, the wire guides 24 are provided as closed channels.

With reference to FIG. 3, it should be noted that an assembly of a telecommunications module and at least one wire guide plate as well as, in the case shown, a cover plate 64 will generally have the same appearance as shown in FIG. 3. In this case, the one or more wire guide plates might not be integral parts of the housing 56 of a telecommunications module 50. Rather, one or more disconnection modules, such as disconnection module 52 shown in FIG. 3, one or more wire guide plates and one or more cover plates can be arranged separate, but in a manner abutting each other so as to constitute a “sandwiched” assembly allowing the same effects to be achieved as with the telecommunications module 50 shown in FIG. 3.

The present invention has now been described with reference to several embodiments thereof. The foregoing detailed description and have been given for clarity of understanding only. No unnecessary limitations are to be understood therefrom. For example, all references to right, left, front and rear are exemplary only and do not limit the claimed invention. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

1-16. (canceled)

17. A wire guide plate for guiding at least one wire to a front side thereof, comprising at least one first wire guide formed on a first surface of the wire guide plate, wherein at least one through opening is formed in the vicinity of the at least one first wire guide so as to guide the at least one wire which is guided by the at least one first wire guide to a second surface of the wire guide plate opposite of the first surface.

18. The wire guide plate in accordance with claim 17, further comprising at least one second wire guide formed on the second surface of the wire guide plate.

19. The wire guide plate in accordance with claim 17, wherein the at least one first wire guide and/or the at least one second wire guide are formed by at least one ridge.

20. The wire guide plate in accordance with claim 19, wherein the at least one ridge extends to a side edge of the through opening.

21. The wire guide plate in accordance with claim 17, wherein the through opening is at least partially covered by at least one roof-type element on at least one surface of the wire guide plate.

22. The wire guide plate in accordance with claim 18, wherein the at least one first wire guide and at least one second wire guide extend from opposite sides of the wire guide plate towards a front side thereof.

23. The wire guide plate in accordance with claim 17 further comprising at least one engaging or mounting structure formed in a rear part of the wire guide plate for engaging with or mounting at least one object, such as a printed circuit board, a shielding plate and/or a protection device.

24. The wire guide plate in accordance with claim 17 further comprising at least one finger extending from a front side of the wire guide plate for separating a plurality of wires or groups of wires from each other.

25. The wire guide plate in accordance with claim 17 further comprising at least one mounting hook for mounting the wire guide plate to a carrier in the field of telecommunications.

26. The wire guide plate in accordance with claim 17, wherein the wire guide plate is integrally formed from a plastic material.

27. An assembly of at least one wire guide plate in accordance with claim 17 and at least one contact module .

28. The assembly of claim 27 wherein the contact module comprises a disconnection module.

29. A telecommunications module comprising at least one wire guide plate in accordance with claim 17.

30. The telecommunications module of claim 29, wherein the telecommunications module comprises a disconnection module.

31. The wire guide plate in accordance with claim 17, further comprising at least one cover plate.

32. The wire guide plate in accordance with claim 31 wherein the cover plate comprises the at least one first wire guide and/or the at least one second wire guide at least partially formed thereon.
